(19) United States
(12) Patent Application Publication
(10) Pub. No.: US 2008/0059219 A1
(43) Pub. Date: Mar. 6, 2008

(54) METHOD OF MANUFACTURING AND OF VERIFYING MAIL ITEMS, THE METHOD GUARANTEEING THAT PAYMENT HAS BEEN MADE

(75) Inventor: Fabien CHATTE, Nogent Sur Marne (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST TECHNOLOGIES, Bagneux (FR)

(21) Appl. No.: 11/837,807

(22) Filed: Aug. 13, 2007

(30) Foreign Application Priority Data
Aug. 31, 2006 (FR) 0653534

(51) Int. Cl. G06Q 30/00

(52) U.S. Cl. 705/1

(57) ABSTRACT

A method of manufacturing a mail item, said method comprising the following steps: a) obtaining the three-dimensional structure of the fibers of said mail item by means of a scanner device; b) determining a unique fingerprint code on the basis of said three-dimensional fiber structure; c) generating a two-dimensional bar code including a unique identification number; d) creating a database associating said unique identification number with said unique fingerprint code; and e) printing said two-dimensional bar code on the mail item. The invention also relates to the method of verifying the mail item manufactured in this way.

### TECHNICAL FIELD

The present invention relates exclusively to the field of mail handling, and it relates more particularly to a method of performing franking via a telecommunications network, which method guarantees to the postal administration that each franked mail item that is entrusted to it for forwarding to the mail item's destination has indeed been paid for by the mail item's sender.

### STATE OF THE ART

The Applicant has proposed, in particular in French Patent Application 05 09183, a method of obtaining franking credit by means of a portable communications device that makes it possible to acquire a unique identification code pre-printed on a mail item or written in a Radio-Frequency Identification (RFID) tag borne by said mail item.

That franking solution is particularly satisfactory for a private individual who can thus, e.g. merely by using a mobile telephone, send mail at any time of the day without paying any attention to the opening hours of the postal services. However, it suffers from a serious drawback for the postal administration when a dishonest user duplicates, on other mail items, a unique identification code that has been previously validated, by payment by an honest user of a postage amount associated with the mail item to be sent.

It is impossible for the postal administration to determine, from among all of the mail items collected in its mail collection offices and bearing the same unique identification code, which mail item has actually been the subject of the above-mentioned payment, and should thus be forwarded to its destination. Unfortunately, if, for example, the postal administration merely forwards the first mail item collected and then rejects the following mail items, it can make a mistake with regard to the honest user who has paid for the franking, and who then has a mail item rejected because a counterfeiter who has copied its unique identification code has arrived before said honest user at a collection office of the postal administration. In which case, the postal administration then might also have to pay compensation to the honest user whose mail item has been unjustly rejected.

A product developed by Ingenia Technology® is known that makes it possible to allocate an identification code uniquely to any item of stationery, and thus could identify any mail item with certainty. That product, which is based on determining the three-dimensional structure (which is unique) of the fibers of any item, is constituted by a scanner that scans the surface of the item of stationery with a laser beam, and extracts from said surface a unique code representing the three-dimensional fiber structure of said item.

Unfortunately, such a technology is currently not suitable for being implemented individually in a portable communications device that currently has only optical reader means of the photographic type or of the bar code type.

### DISCLOSURE OF THE INVENTION

An object of the present invention is therefore to solve that problem of fraudulent duplication with a novel method of franking that guarantees to the postal administration that each mail item forwarded to its destination has indeed been paid for by its sender.

This object is a achieved by a method of manufacturing a mail item, said method comprising the following steps:
a) obtaining the three-dimensional structure of the fibers of said mail item by means of a scanner device;
b) determining a unique fingerprint code on the basis of said three-dimensional fiber structure;
c) generating a two-dimensional bar code including a unique identification number;
d) creating a database associating said unique identification number with said unique fingerprint code; and
e) printing said two-dimensional bar code on the mail item.

Thus, each mail item is associated with a unique fingerprint code which is characteristic of the three-dimensional fiber structure of said mail item and with which a franking amount paid by the sender is associated by means of a portable communications terminal.

Preferably, said two-dimensional bar code also includes one or more of the following elements: address of a franking credit service provider, format of the mail item, and particular postal service associated with the mail item.

Depending on the implementation, the steps c) and e) of generating and printing said two-dimensional bar code can be replaced with a single step of recording said unique fingerprint code (said unique identification number) in an RFID tag borne by the mail item or by the contents thereof.

The invention also provides a method of verifying the existence of payment of the franking amount relating to a mail item on which a two-dimensional bar code is printed, said method comprising the following steps:
a) optically reading said two-dimensional bar code by means of an optical reader device;
b) extracting a unique identification number from said two-dimensional bar code;
c) extracting a first unique fingerprint code from a database associating said unique identification number with said first unique fingerprint code;
d) obtaining the three-dimensional structure of the fibers of said mail item by means of a scanner device;
e) determining a second unique fingerprint code on the basis of said three-dimensional fiber structure; and
f) comparing the first and second unique fingerprint codes, and validating the existence of payment for said mail item if the two codes are identical.

Preferably, one or more of the following elements: address of a server for delivering franking credit, format of the mail item, and particular postal service associated with the mail item, are also extracted from said two-dimensional bar code.

Depending on the implementation, the steps a) and b) of optically reading said two-dimensional bar code and of extracting said unique identification number can be replaced with a single step of reading said unique identification number stored in a RFID tag borne by the mail item or by the contents thereof.

### BRIEF DESCRIPTION OF THE DRAWINGS

Other characteristics and advantages of the present invention appear more clearly from the following description given by way of non-limiting indication, and with reference to the accompanying drawings, in which:

FIG. 1 shows an example of network architecture making it possible to implement the method of the invention for performing franking that guarantees that payment has been made; and

FIG. 2 is a flow chart showing the various steps of the method implemented over the network of FIG. 1.

### IMPLEMENTATION(S) OF THE INVENTION

The invention aims to enable the postal administration to identify with certainty, from among a set of mail items bearing the same pre-printed two-dimensional (2D) identification code, which mail item has been paid for by its sender, by means of an individual franking device such as a mobile communications terminal.

For this purpose, it is proposed to associate, in a correspondence table, this conventional identification code with a fingerprint code that is characteristic of the three-dimensional structure of the fibers of the mail item, the table then being used as an authentication reference.

Thus, if the postal administration collects a plurality of mail items bearing identical 2D codes, it is able to determine which one is the original mail item by comparing the fingerprint code extracted from the correspondence table with the fingerprint code obtained directly by scanning the collected mail item.

In the description below, the term “mail item” is used to mean not only an envelope but also a label designed to be stuck to a thick envelope or to a parcel to be sent.

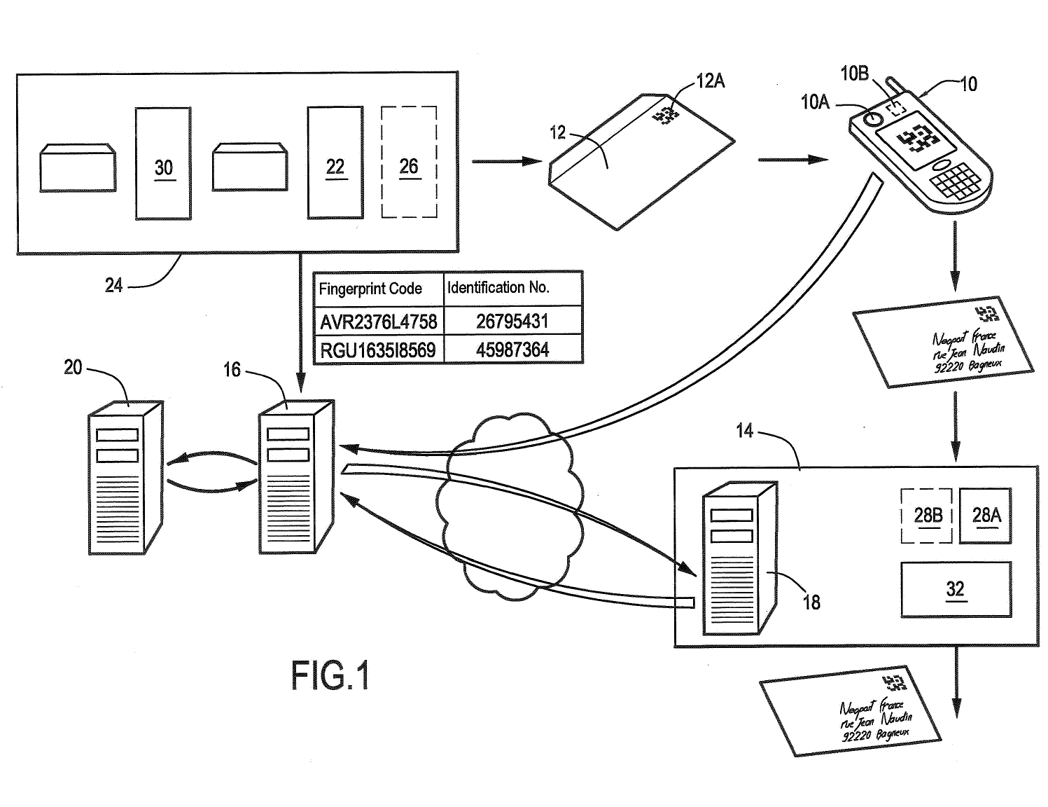

FIG. 1 shows an example of a franking system necessary for implementing the method of the invention. As is known, in particular from above-mentioned Patent Application FR 04 09183, such a system includes a portable communications terminal 10 (mobile telephone, or a web-enabled personal digital assistant (PDA), web-enabled laptop computer, web-enabled games console, etc.) which is used to obtain and to pay for franking credit relating to a mail item 12 to be sent via a mailbox or a collection office of the postal administration 14.

During the process of obtaining franking credit, the portable communications device 10 is put into communication with a dealer server system 16 for delivering franking credit, which server is itself in communication with a server system 18 of the postal administration and optionally with a server system 20 of a telephone operator who optionally debits the amount of the requested franking credit directly from the telephone account held by the user of the portable communications terminal with said telephone operator. Naturally, each of these server systems has one or more databases necessary for managing the various franking data.

Conventionally, the web-enabled portable terminal can either include a digital capture module 10A, such as a digital camera unit or a 2D bar code reader, or a read/interrogate module 10B for reading/interrogating contactless chips, which module then co-operates with a transponder (RFID tag) borne by the mail item or by the contents thereof.

The mail item bears a 2D bar code 12A (such as a code of any one of the following types: Aztec Code, Codablock, Code One, Code 16K, Code 49, Data Matrix, PDF 417, QR Code, or Supercode) pre-printed by printer means 22 during the process of manufacturing the mail item on the premises of a stationery manufacturer 24, thereby guaranteeing the printing quality of the bar code. The high encoding capacity of such a 2D code (comprising up to 4296 characters at the highest end of the performance scale) enables the code to include not only a unique identification number (sequential or random number) but also other information relating to the mail item, such as an indication of format when it is an envelope, an indication of a particular postal service (e.g. registered), or indeed a manufacturer number and a country code, as recommended by the Electronic Product Code (PC) Standard developed by the standardization organization of the same name.

In a variant, the unique identification number and the associated information can be stored via recording means 26 in a contactless chip (or RFID tag) borne by the mail item or by the contents thereof. As is known, this number does not represent any franking amount and thus does not contain any monetary value.

In accordance with the invention, in addition to the printer means 22, the manufacturer 24 of the mail item also has laser scanner means 30, and in addition to the corresponding bar code optical reader means 28A (or, in a variant, in addition to the corresponding RFID tag reader 28B), the collection office of the postal administration also has laser scanner means 32, both of the scanner means using the known Ingenia Technology® method for generating the fingerprint code which is totally unique and which is characteristic of the 3D fingerprint of the paper of which the mail item is made.

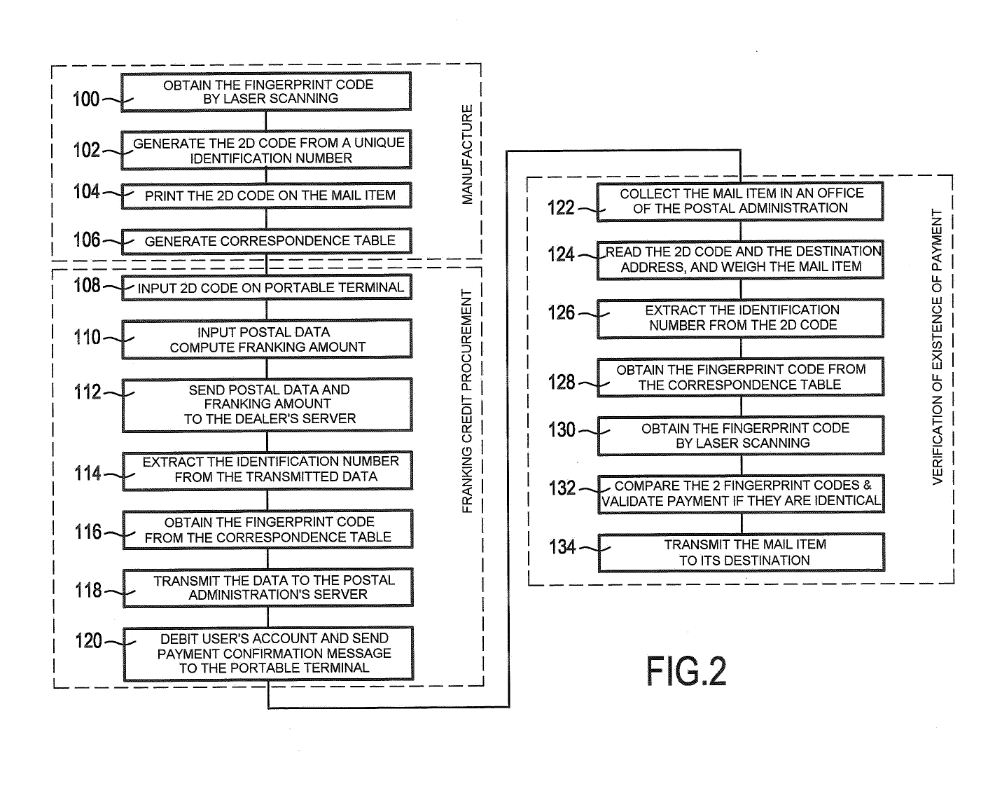

The payment guarantee method implemented in the above-mentioned franking system is described below with reference to FIG. 2. Said method essentially comprises three successive stages: a manufacturing stage during which the mail item is manufactured by a stationery manufacturer; a franking credit procurement stage during which the user obtains franking credit for said mail item; and a payment verification stage during which the postal administration verifies that the franking of said mail item has been paid for.

The mail item manufacturing stage comprises firstly, in a step 100, using a laser scanner to obtain the 3D fingerprint of the paper of which the mail item is made, from which fingerprint a unique fingerprint code is extracted that is characteristic of the 3D structure of the paper. Then, as is known, a 2D bar code is generated, in a step 102, on the basis of a unique identification number and of various information including at least the address of the server of the dealer and optionally the format of the envelope or the particular postal service (registered mail, priority mail, etc.) associated with said envelope when said service is also to be indicated on the envelope. Finally, the 2D code is printed on the mail item in a step 104, and the unique identification number and the unique fingerprint code are stored together in a correspondence table 40 that is generated by the manufacturer of the mail items in a step 106 and that is transmitted to the server of the dealer or that is accessible thereby. These three operations of scanning, of generating the 2D code, and of printing and of storing in the table are repeated for each manufactured mail item, and said mail items are then packaged so as to be put on sale in packets of 50, 100, 200, or 500 envelopes, for example.

The phase during which franking credit is obtained for a mail item to be sent corresponds to the stage described in above-mentioned French Patent Application FR 05 09183 to which reference should be made for further information.

In simplified manner, a sender who has acquired a packet of envelopes bearing said pre-printed 2D code (and optionally bearing an additional indication of the particular postal service desired, e.g. registered mail or priority mail) must then, prior to sending each of said envelopes to its destination, pay the franking amount corresponding to the weight (and optionally to the format) of said envelope and to the desired destination.

For this purpose, the sender must access, in step 108, the pre-recorded franking function of the sender's portable communications terminal and input the 2D code pre-printed on the mail item, via the digital capture means (camera or bar code reader) of said terminal.

In parallel, in step 110, the sender inputs, on the keypad of the terminal, the various postal information necessary for computing the franking amount, such as the destination post code of the mail item, the class of weight (50 cent class if envelope <20 grams (g), 70 cent class if 20 g <envelope <70 g, etc.) and optionally the format of the envelope, the particular postal service desired if said service is not already present on the mail item (as is the indication “registered”, for example). It should be noted that it is possible to imagine inputting the franking amount directly. Once the inputting is complete, the application (step 112) automatically sends to the dealer server whose address has been extracted from the pre-printed code 2D a short message (Short Message Service (SMS) message or Multimedia Messaging Service (MMS) message) including said amount and various other information including the unique identification number and optionally the particular postal service that is desired.

On receiving said message, in a step 114, the server of the dealer extracts the unique identification number from said message. In a step 116, the server of the dealer retrieves the unique fingerprint code that is associated with said number by accessing the correspondence table managed by the manufacturer, the two codes then being stored (with the other information mentioned above and with the identity of the sender obtained from the International Mobile Subscriber Identity (IMSI) number or from the International Mobile Equipment Identity (IMEI) number on setting up of the connection with the portable terminal) in the dealer server's database and being transmitted in parallel in a step 118 to the postal administration (it is also possible to share with said postal administration a right of access to the database).

In parallel, if the user's utilization rights are valid (sufficient credit with the dealer or with the telephone operator), the user's account is then debited for the franking amount and the server of the dealer generates a return message for the user terminal, which message confirms that payment has been made and is in the form of an SMS or MMS message (step 120). The user, informed in this way that the credit has been obtained and that the user's account has been debited for the corresponding amount, can then, without any other formality, go and drop off the mail item in a mailbox or with a collection office of the postal administration.

The stage during which verification is performed by the postal administration can then begin. It consists in ensuring that the payment has genuinely been made by the sender. On receiving a mail item in a collection office of said administration (step 122), the postal administration firstly optically reads the pre-printed 2D code and the destination address), and optionally the particular postal service when said service is also pre-printed on the mail item, e.g. “registered mail” or “priority mail”, and secondly weighs said mail item to determine its class of weight and, on the basis of this information, said postal administration computes the franking amount necessary for said mail item (124).

Reading the 2D code makes it possible, in a step 126, to retrieve the unique identification number and, via the information delivered by the dealer, to retrieve the fingerprint code from the correspondence table in a step 128, and, in a step 132, to compare it with the fingerprint code that the postal administration has obtained by performing laser scanning on the mail item in an immediately preceding step 130. When the two codes are identical, that indicates with certainty that the mail item is authentic (i.e. that the franking amount for the mail item has been paid by the sender), whereas when the laser scanning gives a fingerprint code that is different from the fingerprint code extracted from the 2D code or received from the dealer, that indicates, beyond any shadow of a doubt, that the 2D code is a counterfeit (and therefore is a copy of a genuine code).

If the mail item is authentic, it then merely remains for the postal administration to verify that the credit paid for by the user and associated with the 2D code is at least equal to the computed franking amount for said postal administration to be able to authorize said mail item to be delivered to its destination (final step 134). If the credit is insufficient, the postal administration computes the surcharge to be paid by the person at the destination in order for that person to access the contents of the mail item.

Thus, with the present invention, it is very simple for any user to send any mail item (envelope or parcel) to any destination without having to go to an office of the postal administration, the pre-printed 2D code (which replaces the stamp or the postage mark of a franking machine (postage meter) and which acts to perform the same purpose as such a stamp or postage mark even though it has no monetary value) borne on each mail item being sufficient for the postal administration, in the event that it recognizes the same code twice, to access the fingerprint code and thus to determine with absolute certainty whether the sender of the mail item has indeed paid the franking amount.

It should be noted that although the present invention is described essentially with reference to a mail item provided with a 2D bar code or with a RFID tag, it is possible to imagine, in a simplified version (in particular when the code does not contain postal information relating to the mail item), that the code can be replaced merely with an alphanumeric code formed by a chain of several tens of alphanumeric characters that are machine-readable by means of an Optical Character Recognition (OCR) reader or even, quite simply, that are input directly by the user on the keypad of the user's portable communications device.

What is claimed is:

1. A method of manufacturing a mail item, said method comprising the following steps:
a) obtaining the three-dimensional structure of the fibers of said mail item by means of a scanner device;
b) determining a unique fingerprint code on the basis of said three-dimensional fiber structure;
c) generating a two-dimensional bar code including a unique identification number;
d) creating a database associating said unique identification number with said unique fingerprint code; and
e) printing said two-dimensional bar code on the mail item.

2. A method according to claim 1, wherein said two-dimensional bar code also includes one or more of the following elements: address of a franking credit service provider, format of the mail item, and particular postal service associated with the mail item.

3. A method according to claim 2, wherein the steps c) and e) of generating and printing said two-dimensional bar code are replaced with a single step of recording said unique identification number in an RFID tag borne by the mail item or by the contents thereof.

4. A method of verifying the existence of payment of the franking amount relating to a mail item on which a two-dimensional bar code is printed, said method comprising the following steps:
a) optically reading said two-dimensional bar code by means of an optical reader device;
b) extracting a unique identification number from said two-dimensional bar code;
c) extracting a first unique fingerprint code from a database associating said unique identification number with said first unique fingerprint code;
d) obtaining the three-dimensional structure of the fibers of said mail item by means of a scanner device;
e) determining a second unique fingerprint code on the basis of said three-dimensional fiber structure; and
f) comparing the first and second unique fingerprint codes, and validating the existence of payment for said mail item if the two codes are identical.

5. A method according to claim 4, wherein one or more of the following elements: address of a server for delivering franking credit, format of the mail item, and particular postal service associated with the mail item, are also extracted from said two-dimensional bar code.

6. A method according to claim 4, wherein the steps a) and b) of optically reading said two-dimensional bar code and of extracting said unique identification number are replaced with a single step of reading said unique identification number stored in a RFID tag borne by the mail item or by the contents thereof.
